(19) United States
(12) Patent Application Publication
(10) Pub. No.: US 2006/0050214 A1
(43) Pub. Date: Mar. 9, 2006

(54) Optical sheet for a super twisted nematic display related applications

(75) Inventors: Wei-Duz Hong, Ping Chen City (TW); Ching-Sen Chang, Ping Chen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Optimax Technology Corporation

(21) Appl. No.: 11/062,422

(22) Filed: Feb. 22, 2005

(30) Foreign Application Priority Data
Sep. 7, 2004 (TW) 93127015

(51) Int. Cl. G02F 1/1335

(52) U.S. Cl. 349/117

(57) ABSTRACT

An optical sheet has a uni-axial film and a liquid crystal film. A retardation of the uni-axial film is between 150 nm and 650 nm. The liquid crystal film is placed on one side of the uni-axial film, such that a down view contrast ratio of the optical sheet is at least greater than 2, and a down view range of the optical sheet is greater than 30 degrees.

### RELATED APPLICATIONS

The present application is based on, and claims priority from, Taiwan Application Serial Number 93127015, filed Sep. 7, 2004, the disclosure of which is hereby incorporated by reference herein in its entirety.

### BACKGROUND

1. Field of Invention

The present invention relates to a component of a flat panel display. More particularly, the present invention relates to an optical sheet for a super twisted nematic display.

2. Description of Related Art

Liquid crystal displays (LCD) have many advantages over conventional types of displays including having high display quality, having small volume, being lightweight, and having low driving voltage and low power consumption. Hence, LCDs are widely used in small portable televisions, mobile telephones, video recording units, notebook computers, desktop monitors, projector televisions and so on, and they have gradually replaced the conventional cathode ray tube (CRT) as a mainstream display unit. Therefore, the market is mainly occupied by LCDs, especially due to their high display quality and low power consumption.

A typical liquid crystal display comprises a backlight source, a back polarizer, a liquid crystal layer and a front polarizer. Due to the birefringence of the liquid crystal molecules, light passing through the liquid crystal layer becomes elliptically polarized as a retardation. The retardation makes the liquid crystal display have different brightnesses and grayscales in response to viewing from different view-angles.

Super twisted nematic (STN) liquid crystal molecules are popularly used in the liquid crystal display. The STN liquid crystal molecule can achieve superior display performance due to its large twisted angles. Generally, liquid crystal compensation films are added to the STN display panel to compensate for colors. However, the liquid crystal compensation films do not compensate for the view-angles of the STN display at the same time. The contrast of the STN display without view-angle compensations is decreased when the STN display is tilted. Furthermore, grayscale inversion is then generated and affects display performance.

### SUMMARY

It is therefore an aspect of the present invention to provide a compensation film for a super twisted nematic liquid crystal device, in which a uni-axial film and a liquid crystal film are used together to both compensate for view-angle and color of the super twisted nematic liquid crystal device.

It is another aspect of the present invention to provide an optical sheet for a super twisted nematic liquid crystal device, which compensates for both view-angles and color, and which enables manufacturing thereof that is easily combined with one or more optical films having other functions.

In accordance with the foregoing and other aspects of the present invention, an optical sheet for a super twisted nematic liquid crystal device is provided. The optical sheet comprises a uni-axial film and a liquid crystal film. A retardation of the uni-axial film is between 150 nm and 650 nm. The liquid crystal film is placed on the uni-axial film, such that a down view contrast ratio of the optical sheet is at least greater than 2, and a down view range of the optical sheet is greater than 30 degrees.

According to one preferred embodiment of the present invention, the liquid crystal film comprises twisted nematic liquid crystal molecules, and a material of the uni-axial film is polycarbonate or cycloolefin polymer. The liquid crystal film is a homogeneously aligned liquid crystal film, and a range of angles of the homogeneously aligned liquid crystal film is between 90 degrees and 240 degrees. In the preferred embodiment, the linear polarizing film comprises a first protection layer, a linear polarizing layer and a second protection layer. The first protection layer is placed on the uni-axial film, the linear polarizing layer is placed on the first protection layer, and the second protection layer is placed on the linear polarizing layer.

According to another preferred embodiment of the present invention, the linear polarizing film comprises a linear polarizing layer and a protection layer. The linear polarizing layer is placed on the uni-axial film, and the protection layer is placed on the linear polarizing layer, such that the uni-axial film and the liquid crystal film are used to replace the other protection layer in the foregoing preferred embodiment. Moreover, the liquid crystal film can be a vertically aligned liquid crystal film. In addition, the optical sheet further can comprise an adhesive layer, placed between the uni-axial film and the liquid crystal film. The adhesive layer is a pressure-sensitive adhesive.

The present invention uses the combination of the liquid crystal film and the uni-axial film to achieve the compensations for view-angle and color and is especially suitable for a super twisted nematic liquid crystal device. Moreover, the invention makes R polarizers without compensations in the vertical direction to obtain an additional vertical compensation, and the manufacturing thereof is simple and easily implemented. Furthermore, the compensation film of the present invention can be combined with an optical film having other functions to obtain a multi-functional optical sheet, e.g. a polarizer having compensations for color and view-angles, providing broad applicability in liquid crystal display devices.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a schematic view of one preferred embodiment of the present invention;

FIG. 1B is a schematic view of another preferred embodiment of the present invention;

FIGS. 2A and 2B are schematic views of transfer printing used in one preferred embodiment of the present invention;

FIG. 3A is a schematic view of another preferred embodiment of the present invention; and

FIG. 3B is a schematic view of another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

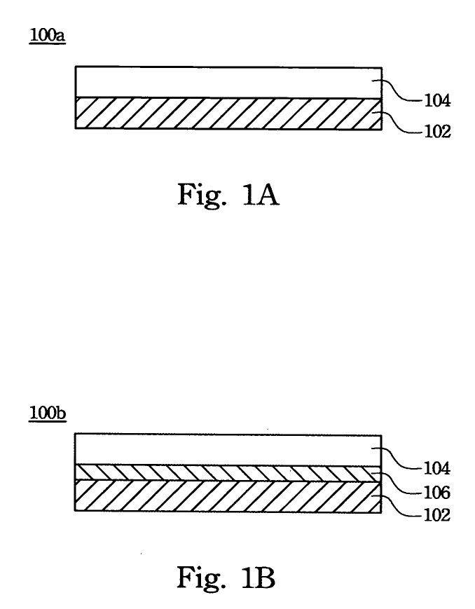

FIG. 1A is a schematic view of one preferred embodiment of the present invention. As illustrated in FIG. 1A, an optical sheet 100a comprises a uni-axial film 102 and a liquid crystal film 104, and is suitable for a super twisted nematic liquid crystal device. A retardation of the uni-axial film 102 is between 150 nm and 650 nm. The liquid crystal film 104 is placed on the uni-axial film 102, such that a down view contrast ratio of the optical sheet 100a is at least 2, and a down view range of the optical sheet 100a is greater than 30 degrees.

It is noted that, in the preferred embodiment, the thicknesses of the uni-axial film 102 and the liquid crystal film 104 are adjustable according to the material of the films, the material of the liquid crystal cell, the wavelength of the backlight source and other factors to achieve the requirements of the down view contrast ratio and the down view range as mentioned above, and thus optimize the performance of the liquid crystal display device.

In the preferred embodiment, the liquid crystal film 104 comprises twisted nematic liquid crystal molecules, and a material of the uni-axial 102 film is polycarbonate or cycloolefin polymer. The liquid crystal film 104 is a homogeneously aligned liquid crystal film with a range of anglesbetween 90 degrees and 240 degrees. However, according to different required compensations, the liquid crystal film can be a vertically aligned liquid crystal film, which also falls into the scope and spirit of the present invention.

FIG. 1B is a schematic view of another preferred embodiment of the present invention. In the preferred embodiment, an optical sheet 100b further comprises an adhesive layer 106 placed between the uni-axial film 102 and the liquid crystal film 104 for satisfying a process requiring or enhancing binding strengths between the films. The preferred embodiment uses a pressure-sensitive adhesive as the adhesive layer 106, and the suitable process thereof is described as follows.

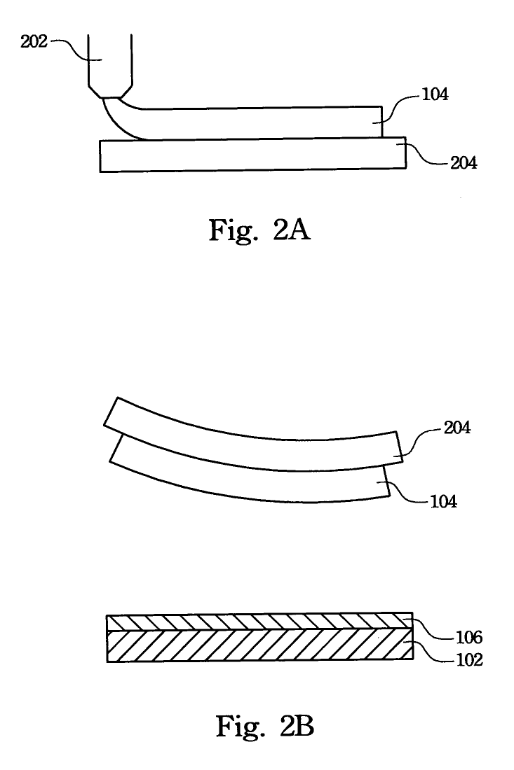

The liquid crystal layer 104 can be combined with the uni-axial layer 102 by direct adhesion, spreading or transfer printing. Direct adhesion and spreading are conventional film processes, and persons skilled in the art can easily use these conventional film processes to join the liquid crystal layer 104 to the uni-axial layer 102. Thus, no further description will be provided here for these processes. FIGS. 2A and 2B are schematic views of the transfer printing used in one preferred embodiment of the present invention, illustrating how to join the liquid crystal film 104 to the uni-axial film 102 by transfer printing.

First, the liquid crystal film 104 is formed on a temporary substrate 204. For example, as illustrated in FIG. 2A, a spread head 202 is used to spread liquid crystal material on the temporary substrate 204 to form the liquid crystal film 104. Then, as illustrated in FIG. 2B, the substrate 204 with the liquid crystal film 104 is pressed against the uni-axial film 102 with the adhesive layer 106 thereon. The adhesive layer 106 used in the preferred embodiment is a pressure-sensitive adhesive of which the stickiness is greater than the stickiness between the liquid crystal film 104 and the substrate 102. Therefore, the liquid crystal film 104 can be successfully transferred onto the uni-axial film 102 by pressing. The thickness of the liquid crystal film 104 used in transfer printing is thinner than for other joining methods and is thus suitable for lightweight and thin applications.

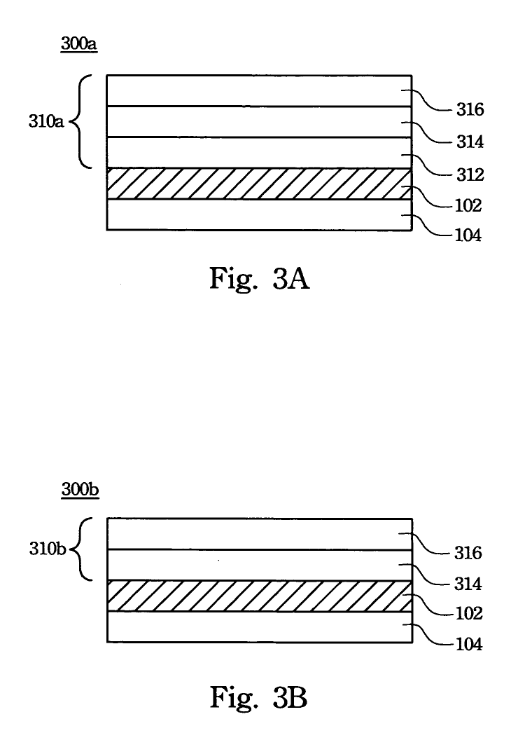

FIG. 3A is a schematic view of another preferred embodiment of the present invention. In this preferred embodiment, in addition to the uni-axial film 102 and the liquid crystal film 104, the optical film 300a comprises a linear polarizing film 310a placed on the other side of the uni-axial film 102. The linear polarizing film 310a comprises a first protection layer 312, a linear polarizing layer 314 and a second protection layer 316a. The first protection layer 312 is placed on the uni-axial film 102, the linear polarizing layer 314 is placed on the first protection layer 312, and the second protection layer 316a is placed on the linear polarizing layer 314.

FIG. 3B is a schematic view of another preferred embodiment of the present invention. In this preferred embodiment, a polarizing film 310b comprises a linear polarizing layer 314 and a protection layer 316b. The polarizing layer 314 is placed on the uni-axial film 102, and the protection layer 316b is placed on the linear polarizing layer 314. The uni-axial film 102 and the liquid crystal film 104 are used to replace the other protection layer 314 in FIG. 3A of the foregoing preferred embodiment. This configuration can reduce components to decrease the thickness and weight of the optical sheet and simplify the manufacturing process.

The material of the linear polarizing layer 314 can be polyvinyl alcohol (PVA) or other suitable conventional material, and the material of the protection layers 312, 316a and 316b can be triacetyl cellulose (TAC) or other suitable conventional material.

It is noted that, adhesive layers can be added between every two adjacent layers illustrated in FIGS. 3A and 3B to enhance the adhesions therebetween. For clarity, the figures and descriptions do not go into further detail regarding the adhesive layers. However, persons skilled in the art should easily understand that implementations of the adhesive layers fall into the scope of the present invention.

The embodiments use the combination of the liquid crystal film and the uni-axial film to achieve the compensations for both view-angle and color and are especially suitable for a super twisted nematic liquid crystal device. Moreover, the embodiments make R polarizers without compensations in the vertical direction to obtain an additional vertical compensation, and the manufacturing thereof is simple and easily implemented. Furthermore, the compensation film of the embodiments can be combined with an optical film having other functions to obtain a multi-functional optical sheet, e.g. a polarizer having compensations for color and view-angles, providing broad applicability in liquid crystal display devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A compensation film for a super twisted nematic liquid crystal device, the compensation film comprising:
a uni-axial film, wherein a retardation of the uni-axial film is between 150 nm and 650 nm; and
a liquid crystal film, placed on the uni-axial film, such that a down view contrast ratio of the compensation film is at least greater than 2, and a down view range of the compensation film is greater than 30 degrees.

2. The compensation film of claim 1, wherein the liquid crystal film is a homogeneously aligned liquid crystal film.

3. The compensation film of claim 2, wherein a range of angles of the homogeneously aligned liquid crystal film is between 90 degrees and 240 degrees.

4. The compensation film of claim 1, wherein the liquid crystal film is a vertically aligned liquid crystal film.

5. The compensation film of claim 1, wherein a material of the liquid crystal film comprises twisted nematic liquid crystal molecules.

6. The compensation film of claim 1, wherein the compensation film further comprises:
an adhesive layer, placed between the uni-axial film and the liquid crystal film.

7. The compensation film of claim 1, wherein the adhesive layer is a pressure-sensitive adhesive.

8. The compensation film of claim 1, wherein a material of the uni-axial film is polycarbonate or cycloolefin polymer.

9. An optical sheet for a super twisted nematic liquid crystal device, the optical sheet comprising:
a uni-axial film, wherein a retardation of the uni-axial film is between 150 nm and 650 nm; and
a liquid crystal film, placed on a first side of the uni-axial film, such that a down view contrast ratio of the optical sheet is at least greater than 2, and a down view range of the optical sheet is greater than 30 degrees.

10. The optical sheet of claim 9, wherein the optical sheet further comprises a linear polarizing film, placed on a second side of the uni-axial film.

11. The optical sheet of claim 10, wherein the linear polarizing film comprises:
a linear polarizing layer, placed on the uni-axial film; and
a protection layer, placed on the linear polarizing layer.

12. The optical sheet of claim 10, wherein the linear polarizing film comprises:
a first protection layer, placed on the uni-axial film;
a linear polarizing layer, placed on the first protection layer; and
a second protection layer, placed on the linear polarizing layer.

13. The optical sheet of claim 9, wherein the liquid crystal film is a homogeneously aligned liquid crystal film.

14. The optical sheet of claim 9, wherein a range of angles of the homogeneously aligned liquid crystal film is between 90 degrees and 240 degrees.

15. The optical sheet of claim 9, wherein the liquid crystal film is a vertically aligned liquid crystal film.

16. The optical sheet of claim 9, wherein a material of the liquid crystal film comprises twisted nematic liquid crystal molecules.

17. The optical sheet of claim 9, wherein the optical sheet further comprises:
an adhesive layer, placed between the uni-axial film and the liquid crystal film.

18. The optical sheet of claim 17, wherein the adhesive layer is a pressure-sensitive adhesive.

19. The optical sheet of claim 1, wherein a material of the uni-axial film is polycarbonate or cycloolefin polymer.
